(19) United States
(12) Patent Application Publication
(10) Pub. No.: US 2011/0120016 A1
(43) Pub. Date: May 26, 2011

(54) Escapeway window guard system

(76) Inventor: Harold Alexander Scott, Plantation, FL (US)

(21) Appl. No.: 12/586,828

(22) Filed: Sep. 29, 2009

(51) Int. Cl. E06B 9/01

(52) U.S. Cl. 49/50

(57) ABSTRACT

Protection has been critical to residential and commercial owners for thousands of years. This is still so, though possibly more so, in today world. Stationary Burglar bars placed over residential and commercial property windows provide a readily visible sign of security. This sign serves both as a deterrent to would-be thieves and an assurance of safety to property owners. As criminal activity has increased, utilization of burglar bars has expanded in cities and towns across the entire United States in response to the ever-increasing threat.

Unfortunately, however successful as a security measure, Burglar bars have also proved to be dangerous. First, stationary burglar bars can create death traps or lead to severe injuries for property occupants by blocking escape in the event of a fire. Second, Fire rescue and EMS personnel often encounter obstacles specific to stationary burglar bars that impede their rescue and/or firefighting efforts, as well as threatening their personal safety. Additionally, when stationary burglar bars are placed over Windows, it is virtually impossible for occupants to escape in non-fire emergencies as well(i.e., robberies, domestic violence, violent weather, etc.) For security bars to be truly safe for use by property owners, the danger hazard must be correct.

Although federal regulations, state laws, local ordinances, codes and standards have been established to regulate residential and commercial burglar security bars products and installation, a huge number of violations still exists throughout the nation. Based on data obtained from the National Fire Protection Association, the number of fire deaths related to stationary burglary bars is on the increase despite the fact that overall the number of fire deaths is on the decline.

### SUMMARY

This invention, one-of-a-kind, is one of the best products ever developed to reduce the number of deaths and injuries from deadly smoke and fire resulting from stationary security burglary bars. Having retired after 23 years with the US Justice Department, I now have the opportunity to bring this product to the market place, giving homeowners a viable alternative to the dangerous burglary bars.

### DESCRIPTION

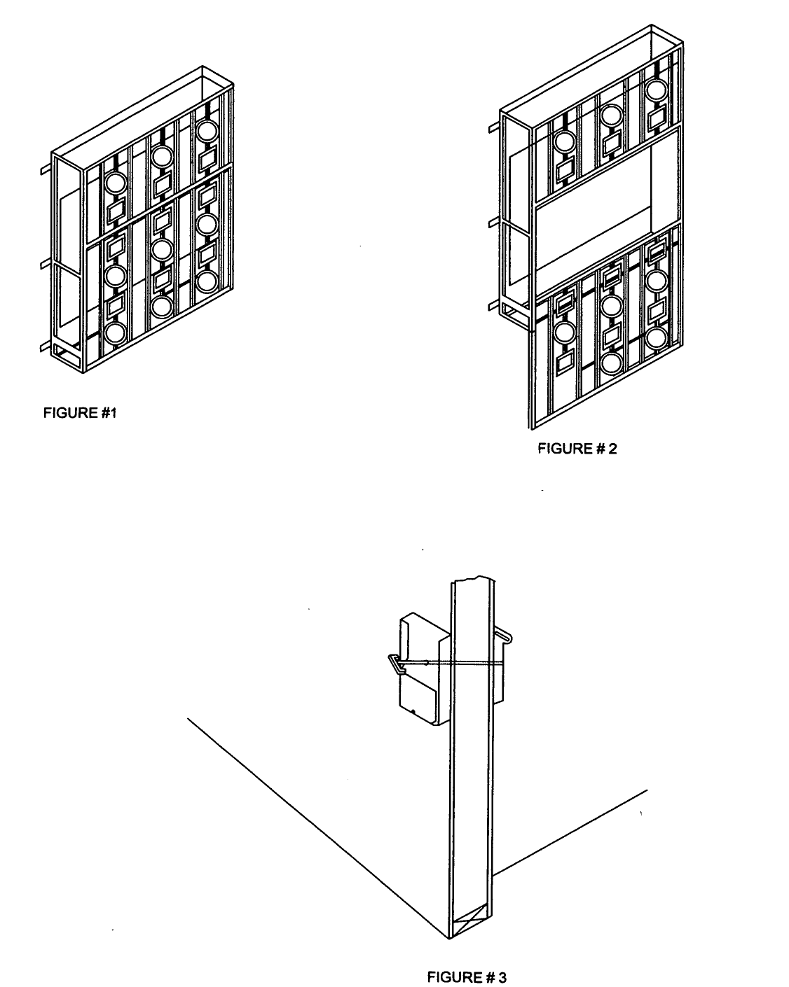

FIG. 1 This is a perspective view from inside and outside look at how the innovative Escapeway window guard system operates.

FIG. 2 The window guard system was designed to offer maximum security and safety to homeowners in case of an emergency such as house fire. With its quick release mechanism, the Escapeway window guard system allow for a fast quick exit through the window. This unique product, once installed, could reverse the rising trend of death and injuries attributed to stationary burglary bars.

Operation:

FIG. 3 The Escapeway Security Window Guard System is constructed of steel and design to be bolted on the outside wall of the window being secured. The operable window guard system operates by the same principle as the single-hung window.

The window guard system is divided into two sections. One section is fixed(stationary).The other one is movable. The release mechanism is located approximately 6 inches below, inside of the window sill, which holds the two sections in place. In an emergency, the handle is pulled(activated), separating both sections. The movable section of the window guard system falls, vertically as in a guillotine, clearing the way for a fast, quick egress through the window for children, elderly, and mobile impaired people. Once danger has passed, the movable section of the window guard can be pulled up and re-positioned to its original position within seconds.

1. The Escapeway Security Window System, meets all the requirements of the National Fire Protection Association, section 101 life safety code, section 22-2.1.1(secondary means of escape). The following Florida state agencies all agree that this innovative security window guard system comply with all the requirements of the National Fire Protection Association(1) Broward County, Fla, Board Of Rules and Appeals .(2) The Florida Department Of Education (Office Of Education facilities-Technical Review-South Florida). (3) The State Of Florida Department Of Insurance And Treasurer (State Fire Marshal Bureau of Fire Prevention).
